(19) United States
(12) Patent Application Publication
(10) Pub. No.: US 2017/0146737 A1
(43) Pub. Date: May 25, 2017

(54) RIGHT-ANGLE WAVEGUIDE BASED ON CIRCULAR-HOLE-TYPE SQUARE-LATTICE PHOTONIC CRYSTAL AND DUAL COMPENSATION SCATTERING CYLINDERS WITH LOW REFRACTIVE INDEX

(71) Applicant: ZHENGBIAO OUYANG, SHENZHEN (CN)

(72) Inventors: Zhengbiao Ouyang, Shenzhen (CN); Hao Huang, Shenzhen (CN)

(73) Assignee: Zhengbiao Ouyang

(21) Appl. No.: 15/396,499

(22) Filed: Dec. 31, 2016

Related U.S. Application Data
(63) Continuation of application No. PCT/CN2015/090873, filed on Sep. 28, 2015.

(30) Foreign Application Priority Data
Sep. 29, 2014 (CN) 201410515301.8

(51) Int. Cl. G02B 6/125; G02B 6/126; G02B 6/122

(52) U.S. Cl. CPC G02B 6/125; G02B 6/1225; G02B 6/1223; G02B 6/126; B82Y 20/00

(57) ABSTRACT

A high-refractive-index double-compensation-scattering-cylinder right-angle waveguide of a hole-type square lattice photonic crystal, being a photonic crystal formed by arranging a first dielectric cylinder having a low refractive index in a background dielectric having a high refractive index in a square lattice; one row and one column of the first dielectric cylinders having a low refractive index are removed from the photonic crystal to form a right-angle waveguide; a second dielectric cylinder and a third dielectric cylinder having low refractive indexes are respectively arranged at two turns of the right-angle waveguide; and the second and third dielectric cylinders are compensation scattering cylinders, and are low-refractive-index cylinders or air holes, and the first dielectric cylinders are low-refractive-index cylinders or air holes. The right-angle waveguide has an extremely low reflectivity and an extremely high transmission rate, thus facilitating an integration of a large-scale light path.

### CROSS-REFERENCE TO RELATED APPLICATIONS

This application is a continuation of International Patent Application No. PCT/CN2015/090873 with a filing date of Sep. 28, 2015, designating the United States, now pending, and further claims priority to Chinese Patent Application No. 201410515301.8 with a filing date of Sep. 29, 2014. The content of the aforementioned applications, including any intervening amendments thereto, are incorporated herein by reference.

### TECHNICAL FIELD

The present invention relates to a photonic crystal bending waveguide, and in particular relates to a right-angle waveguide based on a circular-hole-type dielectric cylinder with low refractive index and a background dielectric square-lattice photonic crystal with high refractive index and dual compensation scattering cylinders with low refractive index.

### BACKGROUND OF THE PRESENT INVENTION

In 1987, E. Yablonovitch from a Bell laboratory of the United States, who was discussing about how to inhibit spontaneous radiation, and S. John from Princeton University, who was discussing about a photon localization, respectively and independently proposed the concept of photonic crystal (PhC). The PhC is a material structure formed in a way that dielectric materials are periodically arranged in space and an artificial crystal which is composed of two or more than two materials with different dielectric constants. The PhC has stronger and flexible control capability for propagation of light and high transmission efficiency for linear transmission and sharp right-angle transmission. If a line defect is introduced into the structure of the PhC, a light guiding channel is created, called as a photonic crystal waveguide (PCW). Even if the waveguide has a 90-degree corner, the waveguide only has a very little loss. Completely different from conventional waveguides with basic total internal reflection, the PCW mainly utilizes a waveguide effect of a defect state; a new photon state is formed inside a photonic band gap (PBG) due to the introduction of the defect, while the photon state density deviating from the defect state is zero. Therefore, the PCW realizes light transmission in a defect mode, without causing mode leakage. The PCW is a basic device for forming optical integrated circuits, the right-angle PCW can improve the integration level of optical circuits, and the research related to right-angle PCWs has important significance for the development of the optical integrated circuits.

### SUMMARY OF PRESENT INVENTION

The present invention aims at overcoming the defects in the prior art to provide a right-angle waveguide based on a circular-hole-type square-lattice photonic crystal and dual compensation scattering cylinders with high refractive index, and the right angle waveguide has extremely low reflectance and very high transmission rate.

The prevent invention is realized through a technical solution below.

The right-angle waveguide based on the circular-hole-type square-lattice photonic crystal and the dual compensation scattering cylinders with low refractive index according to the present invention is built in a PhC formed from first dielectric cylinders with low refractive index arranged in a background dielectric with high refractive index according to a square lattice. In the PhC, one row and one column of said first dielectric cylinders with low refractive index are removed to form said right-angle waveguide. A second and a third dielectric cylinders with low refractive index are respectively arranged at two corners of said right-angle waveguide; said second and said third dielectric cylinders are respectively compensation scattering cylinders; said second and said third compensation scattering cylinders are cylinders with low refractive index or air holes; and said first dielectric cylinders are circular cylinders with low refractive index or air holes.

Said second and said third dielectric cylinders are semi-circular cylinders with low refractive index or air holes, arch shaped cylinders with low refractive index or air holes, circular cylinders with low refractive index or air holes, triangular cylinders with low refractive index or air holes, polygonal cylinders with low refractive index of more than three sides or air holes, or cylinders with low refractive index, of which the outlines of the cross sections are smooth closed curves or air holes.

Said second and said third dielectric compensation scattering cylinders are respectively semi-circular cylinders with low refractive index or air holes.

The material of said first dielectric cylinders with high refractive index is Si, gallium arsenide, titanium dioxide, or a different dielectric with refractive index of more than 2.

The material of said first dielectric cylinders with high refractive index is Si, and the refractive index of Si is 3.4.

Said background dielectric with low refractive index is air, vacuum, magnesium fluoride, silicon dioxide, or a different dielectric with refractive index of less than 1.6.

Said background dielectric with low refractive index is air.

Said right-angle waveguide is a waveguide operating in a transverse electric (TE) mode.

The area of the structure of said right-angle waveguide is more than or equal to 7a*7a, wherein a is the lattice constant of the PhC.

A PhC waveguide device of the present invention can be widely applied in various photonic or optical integrated devices. Compared with the prior art, said right-angle PCW according to the present invention has the positive effects below:

1. Said right-angle waveguide based on said circular-hole-type square-lattice photonic crystal and the dual compensation scattering cylinders with low refractive index according to the present invention has extremely low reflectance and very high transmission rate, thereby providing a greater space for application of said right-angle PCW;

2. The structure of the present invention is based on multiple scattering theory, phase and amplitude compensations for reducing the reflectance and improving the transmission rate of optical waves transmitted in said structure are realized by said dual dielectric compensation scattering cylinders with low refractive index, so as to reduce the reflectance and improve the transmission rate, and therefore, said structure can realize low reflectance and high transmission rate;

3. Said right-angle waveguide based on the circular-hole-type square-lattice photonic crystal and the dual compensation scattering cylinders with low refractive index according to the present invention can be used in design for large-scale optical integrated circuits; the optical circuits are concise and are convenient to design, and said right-angle waveguide facilitates large-scale integration of optical circuits;

4. Said right-angle waveguide based on the circular-hole-type square-lattice photonic crystal and the dual compensation scattering cylinders with low refractive index according to the present invention can realize connection and coupling of different elements in optical circuits and among different optical circuits, thereby being favorable to lowering the cost.

### DESCRIPTION OF THE DRAWINGS

FIG. 1 is the schematic diagram of the core region of the structure of the right-angle waveguide based on a circular-hole-type square-lattice photonic crystal and dual compensation scattering cylinders with low refractive index according to the present invention;

FIG. 2 is the normalized frequency-transmission characteristic diagram of the right-angle waveguide based on the circular-hole-type square-lattice photonic crystal and the dual compensation scattering cylinders with low refractive index according to the present invention.

### DETAILED DESCRIPTION OF PREFERRED EMBODIMENTS

Specific implementation manners of the present invention are further illustrated in combination with the drawings.

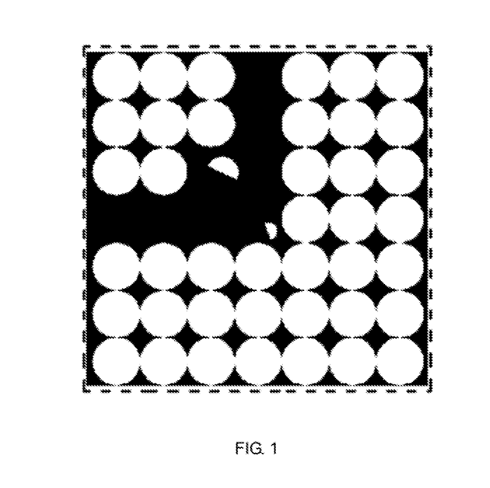

As shown in FIG. 1, a right-angle waveguide based on a circular-hole-type square-lattice PhC and dual compensation scattering cylinders with low refractive index according to the present invention is a PhC formed from said first dielectric cylinders with low refractive index arranged in a background dielectric with high refractive index according to a square lattice. In said PhC, one row and one column of said first dielectric cylinders with low refractive index are removed to form the right-angle waveguide. A second and a third dielectric cylinders with low refractive index are respectively arranged at two corners of the right-angle waveguide; said second and said third dielectric cylinders are respectively compensation scattering dielectric cylinders with low refractive index or air holes; and the compensation reflected waves generated by the second dielectric cylinder are offset by the intrinsic reflected waves in the waveguide without said compensation scattering dielectric; said compensation scattering dielectric cylinders is further adopted as various shapes; for example: the second and the third dielectric cylinders are semi-circular cylinders with low refractive index or air holes, arch-shaped cylinders with low refractive index or air holes, circular cylinders with low refractive index or air holes, triangular cylinders with low refractive index or air holes, polygonal cylinders with low refractive index of more than three sides or air holes or cylinders with low refractive index, of which the outlines of the cross sections are smooth closed curve or air holes. Said second and said third dielectric compensation scattering cylinders are respectively semi-circular cylinders with low refractive index or air holes. The material of said first dielectric cylinders with high refractive index is respectively adopted as Si, gallium arsenide, titanium dioxide, or a different dielectric with refractive index of more than 2. The material of the background dielectric with low refractive index is adopted as air, vacuum, magnesium fluoride, silicon dioxide, or a different dielectric with refractive index of less than 1.6.

Six embodiments are shown below according to the above result:

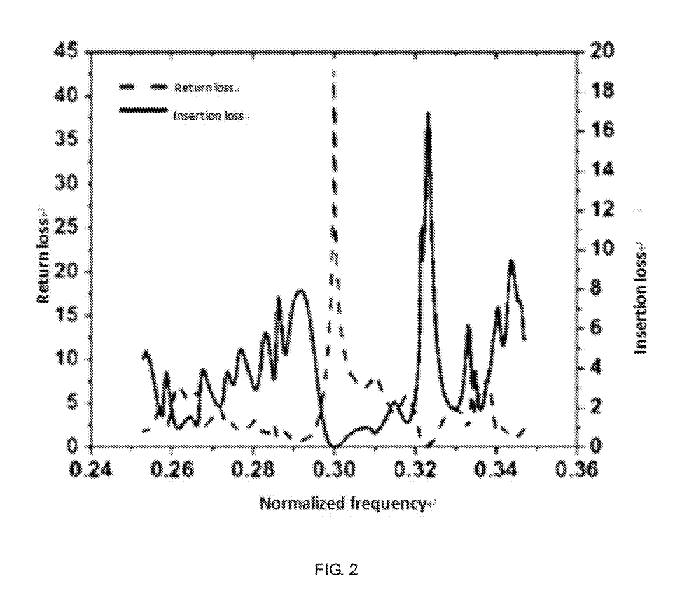

Embodiment 1: the lattice constant of said square lattice PhC is a; said first dielectric cylinders with low refractive index are adopted as circular air cylinders (or known as air holes); the radius of each air cylinder is 0.495a; the polarization of optical waves transmitted in the waveguide is TE form; said second and said third dielectric compensation scattering cylinders are respectively semi-circular air cylinders or known as semi-circular air holes; the radius of the second dielectric cylinder, i.e., a semi-circular compensation scattering air cylinder at the upper left corner is 0.33301a; the displacements of said compensation scattering air cylinder in the X direction and in the Z direction measured from the original benchmark point are respectively 1.62153a and 2.10378a, and the rotation angle is 205.199158 degrees; the reference axis of the rotation angle is the horizontal right-hand axis, and the rotation direction is the clockwise direction; the X axis is in a horizontal right-hand direction, and the Z axis is in a vertical upward direction; the radius of the third dielectric cylinder, i.e., a semi-circular compensation scattering air cylinder at the lower right corner is 0.18591a; the displacements of said compensation scattering air cylinder in the X direction and in the Z direction measured from the original benchmark point are respectively 0.4523a and 0.53514a, and the rotation angle is 250.721844 degrees; the position of an optical source measured from the coordinate origin in the X direction and in the Z direction is (−3.18a, 0); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a, a return loss spectrum and an insertion loss spectrum of the right-angle waveguide formed in the PhC are then obtained and shown in FIG. 2, the horizontal axis part of the figure is the operating frequency of the structure, the longitudinal axis part of the figure indicates the transmission, the dash line in the figure indicates the return loss of the structure (defined as: LR=−10 log (PR/PI), while the solid line in the figure indicates the insertion loss (defined as: LI=−10 log (PT/PI), wherein PI is the incident power of the structure, PR is the reflection power of the structure, and PT is the transmission power of the structure. At the normalized frequency of 0.336(ωa/2πc), the maximum return loss and the minimum insertion loss of the right-angle waveguide formed in the PhC are 43.2 dB and 0.0004 dB.

Embodiment 2: the lattice constant a of said square-lattice PC is 0.465 μm, so that the optimal normalized wavelength is 1.4 μm; said first dielectric cylinders with low refractive index are adopted as circular air cylinders; the radius of each air hole is 0.230175 μm; the polarization of optical waves transmitted in the waveguide is TE form; the second and the third dielectric compensation scattering air cylinders are semi-circular air cylinders; the radius of the second dielectric cylinder, i.e., a semi-circular compensation scattering air cylinder at the upper left corner is 0.154851 μm; the displacements of said compensation scattering air cylinder in the X direction and in the Z direction measured from the original benchmark point are respectively 0.754013 μm and 0.978261 μm, and the rotation angle is 205.199158 degrees; the reference axis of the rotation angle is the horizontal right-hand axis, and the rotation direction is the clockwise direction; the X axis is in a horizontal right-hand direction, and the Z axis is in a vertical upward direction; the radius of the third dielectric cylinder, i.e., a semi-circular compensation scattering air cylinder at the lower right corner is 0.086451 μm; the displacements of said compensation scattering air cylinder in the X direction and in the Z direction measured from the original benchmark point are respectively 0.210320 μm and 0.248844 μm, and the rotation angle is 250.721844 degrees; the position of an optical source measured from the coordinate origin in the X direction and in the Z direction is (−1.4787a, 0)(μm); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a, and the maximum return loss and the minimum insertion loss of the right-angle waveguide formed in the PhC then are 2.884186 and 3.66688 dB.

Embodiment 3: the lattice constant a of said square-lattice PC is 0.465 μm, so that the optimal normalized wavelength is 1.55 μm; said first dielectric cylinders with low refractive index are adopted as circular air holes; the radius of each air hole is 0.230175 μm; the polarization of optical waves transmitted in the waveguide is TE form; the second and the third compensation scattering cylinders are air cylinders or known as semi-circular air holes; the radius of the second dielectric cylinder, i.e., a semi-circular compensation scattering air cylinder at the upper left corner is 0.154851 μm; the displacements of said compensation scattering air cylinder in the X direction and in the Z direction measured from the original benchmark point are respectively 0.754013 μm and 0.978261 μm, and the rotation angle is 205.199158 degrees; the reference axis of the rotation angle is the horizontal right-hand axis, and the rotation direction is the clockwise direction; the X axis is in a horizontal right-hand direction, and the Z axis is in a vertical upward direction; the radius of the third dielectric cylinder. i.e., a semi-circular compensation scattering air cylinder at the lower right corner is 0.086451 μm; the displacements of said compensation scattering air cylinder in the X direction and in the Z direction measured from the original benchmark point are respectively 0.210320 μm and 0.248844 μm, and the rotation angle is 250.721844 degrees; the position of an optical source measured from the coordinate origin in X direction and in the Z direction is (−1.4787a, 0)(μm); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a. At the normalized frequency of 0.3(ωa/2πc), the maximum return loss and the minimum insertion loss of the right-angle waveguide formed in the PhC are 43.2 dB and 0.0004 dB.

Embodiment 4: the lattice constant a of said square lattice PC is 0.3 μm, so that the optimal normalized wavelength is 1.00 μm; said first dielectric cylinders with low refractive index are adopted as circular air holes; the radius of each air hole is 0.1485 μm; the polarization of optical waves transmitted in the waveguide is TE form; the second and the third compensation scattering cylinders are air cylinders or known as semi-circular air holes; the radius of the second dielectric cylinder, i.e., a semi-circular compensation scattering air cylinder at the upper left corner is 0.099903 μm; the displacements of said compensation scattering air cylinder in the X direction and in the Z direction measured from the original benchmark point are respectively 0.486459 μm and 0.631134 μm, and the rotation angle is 205.199158 degrees; the reference axis of the rotation angle is the horizontal right-hand axis, and the rotation direction is the clockwise direction; the X axis is in a horizontal right direction, and the Z axis is in a vertical upward direction; the radius of the third dielectric cylinder, i.e., a semi-circular compensation scattering air cylinder at the lower right corner is 0.055773 μm; the displacements of said compensation scattering air cylinder in the X direction and in the Z direction measured from the original benchmark point are respectively 0.13569 μm and 0.160542 μm, and the rotation angle is 250.721844 degrees; the position of an optical source measured from the coordinate origin in X direction and in the Z direction is (−0.954a, 0)(μm); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a. At the normalized frequency of 0.3(ωa/2πc), the maximum return loss and the minimum insertion loss of the right-angle waveguide formed in the PhC are 43.2 dB and 0.0004 dB.

Embodiment 5: the lattice constant a of said square-lattice PC is 0.444 μm, so that the optimal normalized wavelength is 1.48 μm; said first dielectric cylinders with low refractive index are adopted as circular air holes; the radius of each air hole is 0.21978 μm; the polarization of optical waves transmitted in the waveguide is TE form; the second and the third compensation scattering cylinders are semi-circular air holes or air cylinders; the radius of the second dielectric cylinder, i.e., a semi-circular compensation scattering air cylinder at the upper left corner is 0.147856 μm; the displacements of said compensation scattering cylinder in the X direction and in the Z direction measured from the original benchmark point are respectively 0.719959 μm and 0.934078 μm, and the rotation angle is 205.199158 degrees; the reference axis of the rotation angle is the horizontal right-hand axis, and the rotation direction is the clockwise direction; the X axis is in a horizontal right direction, and the Z axis is in a vertical upward direction; the radius of the third dielectric cylinder, i.e., a semi-circular compensation scattering air cylinder at the lower right corner is 0.082544 μm; the displacements of said compensation scattering air cylinder in the X direction and in the Z direction measured from the original benchmark point are respectively 0.200821 μm and 0.237602 μm, and the rotation angle is 250.721844 degrees; the position of an optical source measured from the coordinate origin in X direction and in the Z direction is (−1.41192a, 0)(μm); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a. At the normalized frequency of 0.3(ωa/2πc), the maximum return loss and the minimum insertion loss of the right-angle waveguide formed in the PhC are 43.2 dB and 0.0004 dB.

Embodiment 6: the lattice constant a of said square lattice PC is 150 μm, so that the optimal normalized wavelength is 500 μm; said first dielectric cylinders with low refractive index are adopted as circular air holes; the radius of each air hole is 74.25 μm; the polarization of optical waves transmitted in the waveguide is TE form; the second and the third dielectric compensation scattering cylinders are semi-circular air cylinders or known as air holes; the radius of the second dielectric cylinder, i.e., a semi-circular compensation scattering air cylinder at the upper left corner is 49.9515 μm; the displacements of said compensation scattering cylinder in the X direction and in the Z direction measured from the original benchmark point are respectively 243.2295 μm and 315.567 μm, and the rotation angle is 205.199158 degrees; the reference axis of the rotation angle is the horizontal right axis, and the rotation direction is the clockwise direction; the X axis is in a horizontal right direction, and the Z axis is in a vertical upward direction; the radius of the third dielectric cylinder, i.e., a semi-circular compensation scattering air cylinder at the lower right corner is 27.8865 μm; the displacements of said compensation scattering air cylinder in the X direction and in the Z direction measured from the original benchmark point are respectively 67.845 μm and 80.271 μm, and the rotation angle is 250.721844 degrees; the position of an optical source measured from the coordinate origin in X direction and in the Z direction is (−477, 0)(μm); and the initial phase of incident light (the optical source) is 150.5 degrees. The background dielectric with high refractive index is Si, and the refractive index of Si is 3.4; and the dielectric with low refractive index is air. The structure size of the right-angle waveguide formed in the PhC is 15a*15a. At the normalized frequency of 0.3(ωa/2πc), the maximum return loss and the minimum insertion loss of the right-angle waveguide formed in the PhC are 43.2 dB and 0.0004 dB.

The above detailed description is only for clearly understanding the present invention and should not be taken as an unnecessary limit to the present invention. Therefore, any modification made to the present invention is apparent for those skilled in the art.

We claim:

1. A right-angle waveguide based on a circular-hole-type square-lattice photonic crystal and dual compensation scattering cylinders with low refractive index, characterized in that: said right-angle waveguide is built in a photonic crystal (PhC) formed from said first dielectric cylinders with low refractive index arranged in a background dielectric with high refractive index according to square lattice; in said PhC, one row and one column of said first dielectric cylinders with low refractive index are removed to form the right-angle waveguide; a second and a third dielectric cylinders with low refractive index are respectively arranged at two corners of the right-angle waveguide; said second and said third dielectric cylinders are respectively compensation scattering cylinders; said second and said third dielectric compensation scattering cylinders are cylinders with low refractive index or air holes; and said first dielectric cylinders are circular cylinders with low refractive index or air holes.

2. The right-angle waveguide based on said circular-hole-type square-lattice photonic crystal and said dual compensation scattering cylinders with low refractive index according to claim 1, characterized in that: said second and said third dielectric cylinders are semi-circular cylinders with low refractive index or air holes, arch shaped cylinders with low refractive index or air holes, circular cylinders with low refractive index or air holes, triangular cylinders with low refractive index or air holes, polygonal cylinders with low refractive index of more than three sides or air holes, or cylinders with low refractive index, of which the outlines of the cross sections are smooth closed curves or air holes.

3. The right-angle waveguide based on said circular-hole-type square-lattice photonic crystal and said dual compensation scattering cylinders with low refractive index according to claim 2, characterized in that: said second and said third dielectric cylinders are respectively semi-circular cylinders with low refractive index or air holes.

4. The right-angle waveguide based on said circular-hole-type square-lattice photonic crystal and said dual compensation scattering cylinders with low refractive index according to claim 1, characterized in that: the material of said first dielectric cylinders with high refractive index is Si, gallium arsenide, titanium dioxide, or a different dielectric with refractive index of more than 2.

5. The right-angle waveguide based on said circular-hole-type square-lattice photonic crystal and said dual compensation scattering cylinders with low refractive index according to claim 4, characterized in that: the material of said first dielectric cylinders with high refractive index is silica, and the refractive index of Si is 3.4.

6. The right-angle waveguide based on said circular-hole-type square-lattice photonic crystal and said dual compensation scattering cylinders with low refractive index according to claim 1, characterized in that: the material of said background dielectric with low refractive index is air, vacuum, magnesium fluoride, silicon dioxide, or a different dielectric with refractive index of less than 1.6.

7. The right-angle waveguide based on said circular-hole-type square-lattice photonic crystal and said dual compensation scattering cylinders with low refractive index according to claim 6, characterized in that said background dielectric with low refractive index is air.

8. The right-angle waveguide based on said circular-hole-type square-lattice photonic crystal and said dual compensation scattering cylinders with low refractive index according to claim 1, characterized in that: said right-angle waveguide is a waveguide operating in a TE mode.

9. The right-angle waveguide based on said circular-hole-type square-lattice photonic crystal and said dual compensation scattering cylinders with low refractive index according to claim 1, characterized in that: the area of the structure of said right-angle waveguide is more than or equal to 7a*7a, and a is the lattice constant of the PhC.
